(19) United States
(12) Patent Application Publication
(10) Pub. No.: US 2005/0027954 A1
(43) Pub. Date: Feb. 3, 2005

(54) Method and apparatus to support the maintenance and reduction of FLASH utilization as it pertains to unused or infrequently referenced FLASH data

(76) Inventors: Michael A. Rothman, Olympia, WA (US); Vincent J. Zimmer, Federal Way, WA (US); Greg P. McGrath, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/633,010

(22) Filed: Aug. 1, 2003

(51) Int. Cl. G06F 12/00

(52) U.S. Cl. 711/159; 711/103

(57) ABSTRACT

A method and apparatus for managing memory usage. Whether a file stored on a user/hardware accessible portion of a non-volatile memory device in a computing system has been accessed within a predetermined period is determined. If the file has not been accessed within the pre-determined period, the file is purged to enable the recovery of storage space in the user/hardware accessible portion of the non-volatile memory device being occupied by unused or infrequently accessed files.

### BACKGROUND OF THE INVENTION

1. Field of the Invention

The present invention is generally related to managing non-volatile memory. More particularly, the present invention is related to a method for managing a user-accessible region of a non-volatile memory device.

2. Description

In computing systems, such as servers, workstations, and/or personal computers (PCs), non-volatile memory may include non-volatile Random Access Memory (NVRAM), such as, for example, a FLASH device. A portion of the FLASH device may be user accessible. The availability of the user-accessible region of the FLASH device is a recent advent to computing systems, and is mainly used by high-end computing systems, such as servers. High-end servers use this region of the FLASH device to store user generated files/variables, firmware generated files/variables, and/or hardware generated files/variables. Hardware generated files may include, but are not limited to, configuration data from devices, such as add-in circuit cards.

Currently, most add-in circuit cards have their own variable space on the card, and therefore do not use the user accessible region of the FLASH device. As the user accessible region of the FLASH device becomes more ubiquitous, manufacturers will develop more devices that take advantage of this user space to reduce costs. And, in fact, this may already be happening because various devices/agents are now vying to store information on the user accessible region of the FLASH more frequently.

In many platforms today, the user accessible region of the FLASH is approximately one fourth of the total capacity of the FLASH memory device, which limits the amount of non-volatile storage available to the user, firmware, and/or hardware devices/agents. Thus, with more and more devices or agents vying to utilize the user accessible region, the availability of free space on the user accessible region of the FLASH diminishes.

In many instances, a large portion of the data stored in the user accessible region of the FLASH is either unused or rarely accessed. For example, when a circuit card is added to a system, it may occupy some of the user accessible region of the FLASH with its configuration data, but when the circuit card is either moved to another slot in a chassis or completely removed from the system, the configuration data placed in the user accessible region likely remains. Currently, no methods exist for removing unused or rarely accessed data in the user accessible region to free-up space for other legitimate non-volatile stores.

Thus, what is needed is a method for determining unused or infrequently-referenced data stored in a user accessible region of a non-volatile storage device. What is also needed is a method for managing unused or infrequently-referenced data stored in the user accessible region of the non-volatile storage device. What is further needed is a method for purging or removing unused or infrequently-referenced data from the user accessible region of the non-volatile storage device to free-up space for other legitimate non-volatile stores.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary FLASH memory device.

FIG. 2 is a diagram illustrating exemplary content for a user/hardware variable space of a FLASH memory device.

FIG. 3 is a flow diagram illustrating a method for recovering storage on a user/hardware variable space of a FLASH memory device via user interaction according to an embodiment of the present invention.

FIG. 4A is a diagram illustrating an exemplary firmware program menu according to an embodiment of the present invention.

FIG. 4B is a diagram illustrating an exemplary system maintenance window according to an embodiment of the present invention.

FIG. 4C is a diagram illustrating an exemplary window for viewing FLASH content according to an embodiment of the present invention.

FIG. 5 is a state diagram describing a method for managing user/hardware variable space in a FLASH memory device during system boot and system operation according to an embodiment of the present invention.

FIG. 6 is a flow diagram illustrating an exemplary method for managing FLASH utilization as it pertains to unused or infrequently referenced FLASH data according to an embodiment of the present invention.

FIG. 7 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a method and apparatus for tracking access patterns of FLASH usage to manage resources on expensive persistent stores, namely a user/hardware variable portion of a non-volatile Random Access Memory (NVRAM), such as a FLASH device. This is accomplished by implementing access-aging type policies to enable the recovery of storage space being occupied by data not recently accessed, thus making a system self-regulating. This also helps to prevent DoS (Denial of Service) attacks by regulating the availability of user/hardware FLASH space to prevent the system from running out of available user/hardware FLASH space. The data not recently accessed or used may be purged or offloaded to a different non-volatile storage device automatically. In one embodiment, a user may also be prompted to select files to be purged or offloaded to a different non-volatile storage device.

Embodiments of the present invention are described as being implemented in systems using FLASH memory devices. One skilled in the relevant art(s) would know that embodiments of the present invention may also be implemented in systems using other types of non-volatile RAMs that allow user/hardware variable stores.

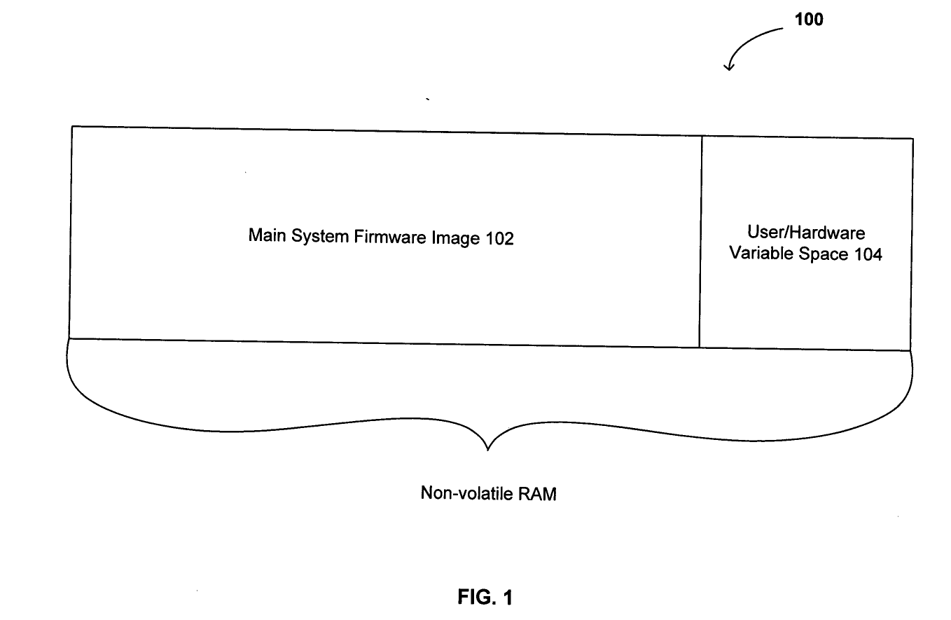

FIG. 1 is a block diagram illustrating an exemplary non-volatile random access memory (NVRAM) device. NVRAM devices are types of memory devices that retain their contents when power is turned off. One such NVRAM device may be a FLASH device, such as a FLASH device 100 shown in FIG. 1. Flash device 100 comprises a main system firmware image 102 and a user/hardware variable space 104. In typical FLASH devices, main system firmware image 102 comprises approximately 75% of the memory capacity while user/hardware variable space 104 comprises approximately 25% of the memory capacity. Thus, a primary usage of FLASH 100 is for storing main system firmware image 102 and a secondary usage of FLASH 100 is for user/hardware accessible storage. For example, a FLASH device with a 4M byte memory capacity may allocate 1M byte of memory space to user/hardware variable space 104. In an alternative example, a FLASH device with a 256K byte memory capacity may allocate 64K bytes of memory space to user/hardware variable space 104. One skilled in the relevant art(s) would know that other memory allocation percentages for main system firmware image 102 and user/hardware variable space 104 are also possible.

Main system firmware image 102 is used to store computer program code. The computer program code may include, but is not limited to, basic input/output system code, application programs, subroutines, data conversion tables, high-level language programs, etc. In one embodiment of the present invention, main system firmware image 102 may include computer program code for managing FLASH utilization as it pertains to unused or infrequently referenced FLASH data in user/hardware variable space 104.

User/hardware variable space 104 may be used to store files and/or variables from a user, main system firmware image 102, and hardware components, such as, for example, add-in circuit cards. Currently, firmware does not prevent the usage of user/hardware variable space 104 by varying devices/agents, such as, but not limited to, add-in cards, firmware drivers, and present operating system applications. For example, high-end server type platforms, using such processors as an Intel® Itanium® 2 processor, manufactured by Intel Corporation, frequently use non-volatile storage space, such as user/hardware variable space 104, to save state information about the system, configuration related information, or other types of information suitable for storing in non-volatile storage space. As desktop platforms evolve, they too will be using some type of non-volatile storage, such as, for example, user/hardware variable space 104 in FLASH device 100 to save state information, configuration related information, or other types of information suitable for storing in non-volatile storage space.

Today, user/hardware variable space 104 is being used more often by devices/agents vying for non-volatile storage space. This results in diminished free space in user/hardware variable space 104 of FLASH device 100. For example, often times devices/agents will store files and/or variables in user/hardware variable space 104 with the intent of being used as temporary scratch space. Other times devices/agents will store files and/or variables in user/hardware variable space 104, but the files and/or variables are rarely accessed. In both instances the temporary scratch space or rarely accessed files and/or variables remain within FLASH device 100, thereby limiting the availability of user/hardware variable space 104 to be used by other devices/agents vying for non-volatile storage.

As user/hardware variable space 104 is used more and more by devices/agents, rarely accessed files and/or variables occupying space in user/hardware variable space 104 may cause Denial-of-Service (DoS) attacks if all of the free space in user/hardware variable space 104 is depleted.

For example, if an adapter card storing information in user/hardware variable space 104, such as an EFI (Extensible Firmware Interface) variable, is subsequently removed from the system, the EFI variable remains in user/hardware variable space 104. Thus, the EFI variable remaining in the system after the subsequent removal of the adapter card is now orphaned, only to take up FLASH variable space in perpetuity. (Note that EFI is an interface between an operating system and platform firmware. EFI variables may include data tables that contain platform-related information and boot and runtime service calls that are available to the operating system and its loader.) Other examples include applications that store EFI variables or firmware files for temporary storage as part of their normal flow, but omit deletion of the temporary store after completion of the execution of the applications. At some point in time, user/hardware variable space 104 could become polluted with unused or infrequently accessed files/variables such that no space may be available to save files/variables, such as, but not limited to, configuration data for a hardware device. This could result in failing scenarios due to the lack of available user/hardware variable space 104 in FLASH 100.

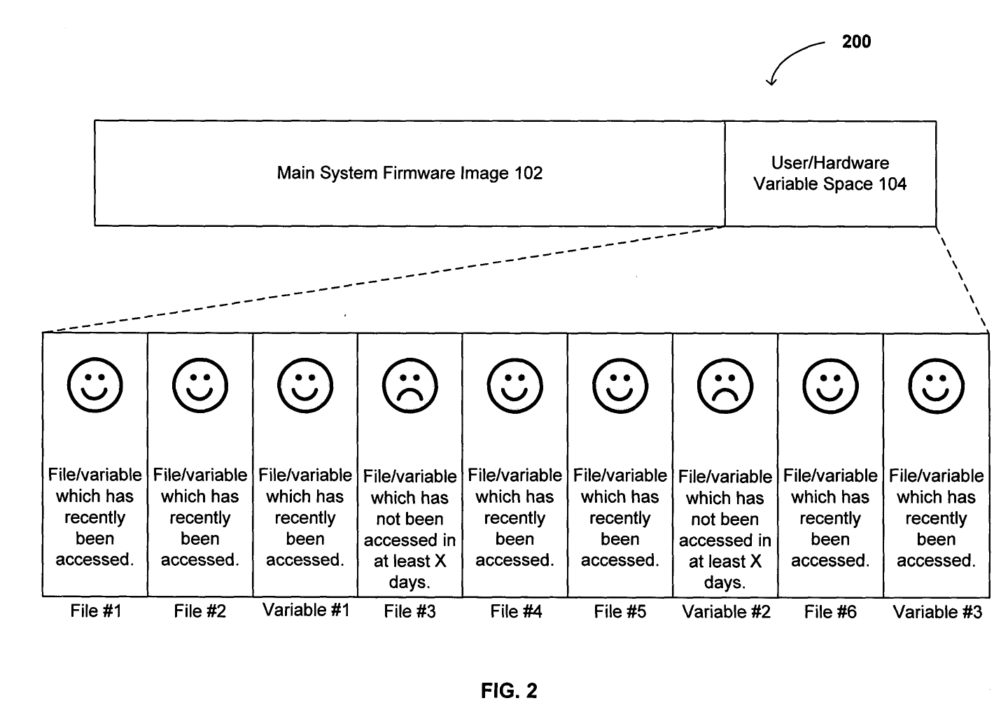

FIG. 2 is a diagram illustrating exemplary content 200 for user/hardware variable space 104. Content 200 comprises a plurality of files (File 1-File 6) and a plurality of variables (Variable 1-Variable 3). Variables are representative of the namespaces being used to store information. Files/variables that have been recently accessed are represented by a happy face. Files/variables that have not been accessed in at least X days, where X is predefined by system policy, are represented by a sad face. In the example shown in FIG. 2, File 3 and Variable 2 have not been accessed in at least X days and are taking up FLASH variable space that could be used by a user, firmware, or a device/agent needing to use the non-volatile store for a legitimate reason.

As previously stated, embodiments of the present invention are directed to a method and apparatus for tracking access patterns of FLASH usage to manage resources on an expensive persistent store, namely the user/hardware portion (104) of FLASH device 100. This is accomplished by implementing access-aging type policies to enable the recovery of storage space being occupied by data not recently accessed. In one embodiment, the method is performed automatically. In another embodiment, the method may require user interaction.

Access-aging policies may be based on several factors, such as, but not limited to, the type of platform in which the FLASH device is implemented (e.g., server vs. desktop), the amount of non-volatile storage in a particular platform (e.g., 4 Mbytes for a server platform vs. 256 Kbytes for a desktop platform), the expected user type for the particular platform, restrictions put on the usage of the non-volatile storage, etc. So, for example, in one embodiment, X days, represented in FIG. 2, may be 7 days, and any file/variable that has not been accessed in at least 7 days may be considered to be unused, infrequently referenced, or “stale” data. In another embodiment, X days may be 30 days, and any file/variable that has not been accessed in at least 30 days may be considered to be unused, infrequently referenced, or “stale” data. Yet in another embodiment, the policy may be to define X days as 100 days, but if user/hardware variable space 104 becomes low on free space, policy may dictate that X days be redefined to 30 days, for example, and that any file/variable that has not been accessed in at least 30 days be redefined as “stale” data.

Policy may also dictate whether to enable user-generated requests to clean-up or recover storage space on user/hardware variable space 104 or whether to provide a completely automated mechanism to auto-prune the “stale” files within user/hardware variable space 104. In an embodiment, policy may require the user to request that user/hardware variable space 104 be checked to determine whether “stale” files are to be purged or removed. In one such embodiment, the user may interact with the system to determine which “stale” files are purged or removed.

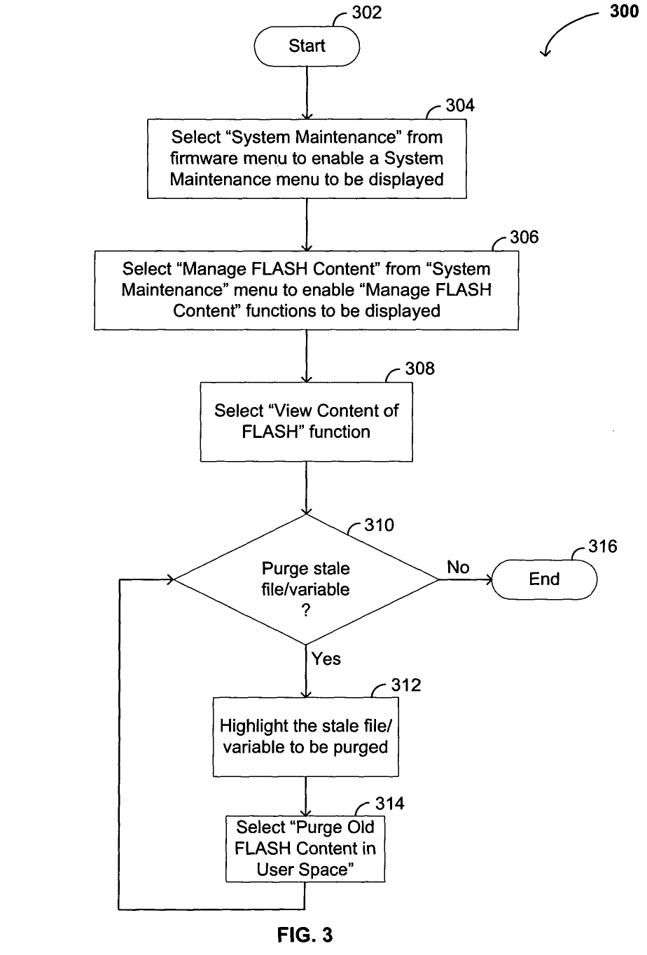

FIG. 3 is a flow diagram 300 illustrating a method for recovering storage space on a FLASH device via user interaction according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention.

Since access to FLASH 100 is available while main system firmware image 102 is running as well as while the operating system is running, the recovery of non-volatile storage may occur during a system boot and/or during system operations. The process begins with block 302, where the process immediately proceeds to block 304.

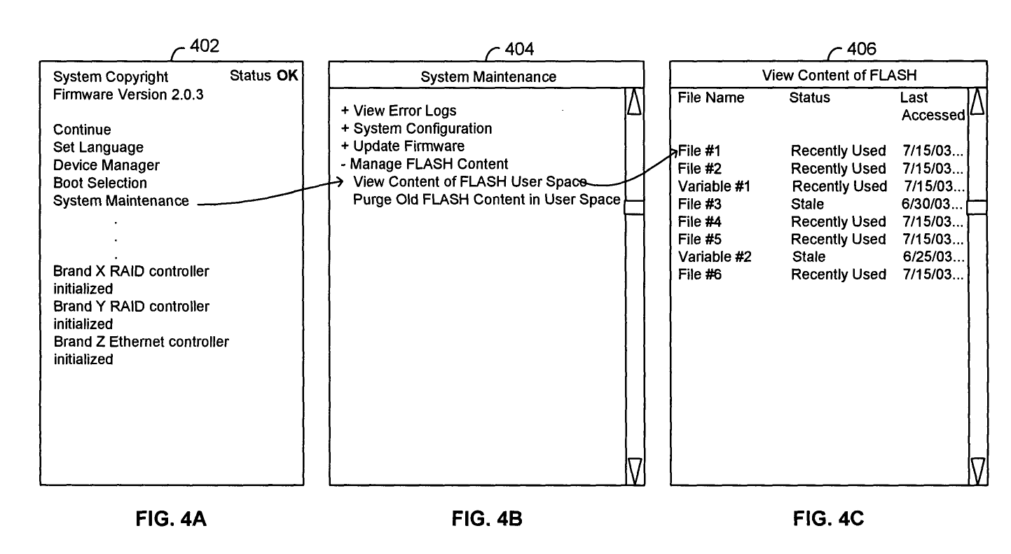

As previously indicated, main system firmware image 102 of FLASH memory device 100 may provide a user with the ability to manage FLASH content for user/hardware variable space 104. In one embodiment, the firmware program may provide a menu of various functions available for selection by the user. An exemplary firmware program menu 402 is shown in FIG. 4A. One of the functions listed on the menu in FIG. 4A is “System Maintenance”. The System Maintenance function acts as a gateway to managing FLASH content. In other words, in order to manage the FLASH content, the user may select the “System Maintenance” function from the firmware menu in block 304. The selection of “System Maintenance” enables a System Maintenance menu to be displayed. The System Maintenance menu lists functions such as, but not limited to, viewing error logs, system configuration, updating firmware, and managing FLASH content. An exemplary System Maintenance menu 404 is shown in FIG. 4B.

To manage the FLASH content, the user may select “Manage FLASH Content” from the System Maintenance window (shown in FIG. 4B) in block 306. The selection of “Manage FLASH Content” enables the user to (1) view the content of the FLASH and (2) purge old FLASH content.

In order for the user to purge old FLASH content, the user must first know what old FLASH content is available to purge. Thus, in block 308, the user may select “View Content of FLASH”. The selection of “View Content of FLASH” enables a View Content of FLASH window to be presented to the user. An exemplary View Content of FLASH window 406 is shown in FIG. 4C. View Content of FLASH window 406 may provide, but is not limited to, a list of each file/variable name and the status of the file/variable. The status of the file/variable may indicate whether the file/variable has been recently used or is considered to be a “stale” file/variable. A “stale” file/variable is one that has not been accessed in a certain length of time. The length of time may vary from one system to another based on policy reasons, as described above. Other information may also be included, such as, but not limited to, date/time data indicating the last time the file was accessed, the size of the data, etc.

In decision block 310, the user may determine whether to purge a file/variable that has been labeled “stale”. If the user determines that a file/variable needs to be purged, the user may highlight the file/variable to be purged on the View Content of FLASH window (block 312) and then select the “Purge Old FLASH Content” function on the System Maintenance menu (block 314) to purge the file/variable. In one embodiment, the selected file/variable may be purged from FLASH 100, but may not be purged from the system. Instead, the “stale” file/variable may be offloaded to another non-volatile storage device. Whether the “stale” file/variable is purged from the system or offloaded to another non-volatile storage device is based on the policy of the system. The process then returns to decision block 310 to determine whether to purge another file that has been labeled “stale”.

In decision block 310, if the user determines that there are no files that need to be purged, the process proceeds to block 316, where the process ends.

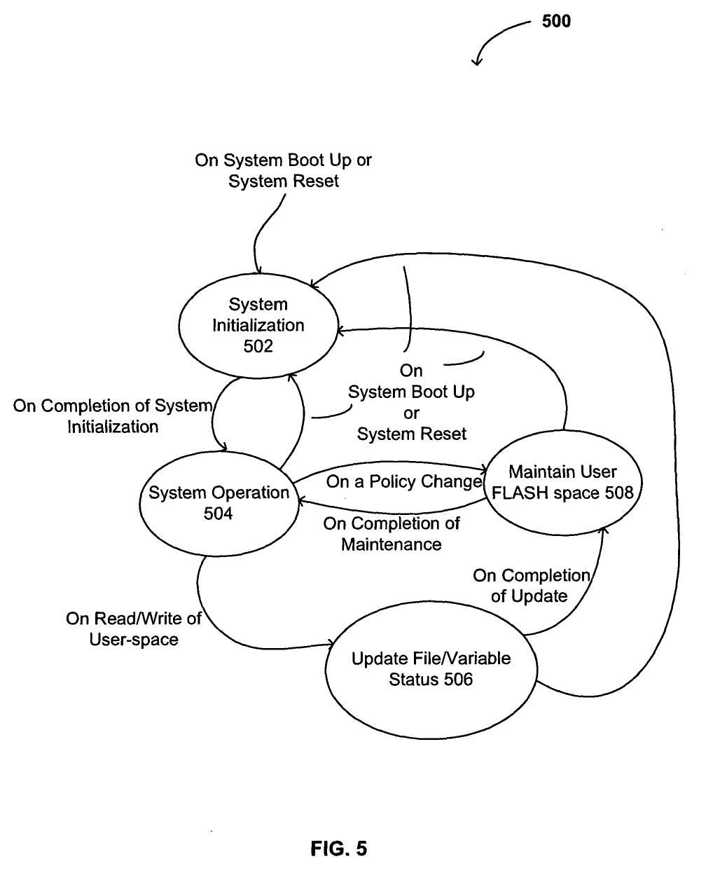

FIG. 5 is a state diagram 500 describing a method for managing user/hardware variable space in a FLASH memory device during system boot and system operation according to an embodiment of the present invention. The invention is not limited to the embodiment described herein with respect to state diagram 500. Rather, it will be apparent to persons skilled in the relevant art(s) after reading the teachings provided herein that other functional state diagrams are within the scope of the invention.

On either a boot-up or a reset, an initialization state 502 is entered. During initialization state 502, a BIOS (Basic Input/Output System) is executed. For a cold boot (boot-up), the BIOS turns on and initializes the power supply and performs a power-on self test. The BIOS searches for a video card and executes the video card BIOS, which initializes the video card. If other devices' ROMs have BIOSes, then these BIOSes are executed as well. The BIOS also displays a startup screen and performs more tests on the system, including a memory count-up test (which may be displayed on the screen).

During boot-up or reset, the BIOS performs a system inventory to determine what hardware is in the system, performs memory timing based on the type of memory it finds, and dynamically sets hard drive parameters and access modes. The BIOS also searches for and labels logical devices, such as, but not limited to, COM and LPT ports, detects and configures devices that support a plug and play standard, and displays a summary screen about the system's configuration.

In one embodiment, the BIOS may check user/hardware variable space 104 in FLASH 100 to determine whether “stale” files/variables exist during initialization. If “stale” files/variables do exist, a warning may be displayed during boot-up or reset, if policy permits. In one embodiment, the user may be presented with the system maintenance option to view and select the “stale” files/variables to be purged, as described above with reference to FIG. 3. In another embodiment, the system may automatically purge any “stale” files/variables by deleting them or offloading them to an alternate storage device. Whether to enable a user to select which “stale” files/variables to purge or whether to enable the system to automatically purge the files/variables designated as “stale” may be a policy decision based on heuristics that are platform specific.

The BIOS will then search for a drive to boot from, such as from a floppy disk, a hard disk, a CD-ROM (Compact Disk-Read Only Memory) drive, or other device. The BIOS, after locating the boot drive, will look for boot information to start the operating system boot process, and upon finding the boot information, will start the process of booting the operating system from the BIOS.

After successfully booting the operating system, the process will proceed to a system operation state 504, where the system performs computing operations based on the operating system.

In one embodiment, user/hardware variable space 104 may be monitored for space availability during system operation state 504. In other words, user/hardware variable space 104 may be monitored to determine when space 104 is getting too full. In one embodiment, when user/hardware variable space 104 is identified as being too full, a warning may be displayed to the user. In another embodiment, the system may alter its policy as to how long a file/variable may be unused or infrequently accessed before it is determined to be “stale” in order to remove some of the files/variables being stored on user/hardware variable space 104. For example, if the original policy is to remove files/variables that have not been accessed in at least 30 days, the altered policy may be to remove files/variables that have not been accessed in at least 15 days in order to remove some of the existing files/variables being stored on user/hardware variable space 104. When the policy is altered, the process will proceed to maintain user FLASH space state 508.

In another embodiment, during system operation state 504, files/variables that are to be written to user/hardware variable space 104 are checked for size. If the size of the file/variable exceeds or diminishes too much of the available space in user/hardware variable space 104, the file/variable may not be stored in user/hardware variable space 104. In one embodiment, the file/variable may be pushed onto an alternate non-volatile storage device instead. Later, if the file/variable is needed, the system will look to the alternate storage location if the file/variable cannot be found in user/hardware variable space 104.

In one embodiment, when a user-space file/variable is utilized, (i.e., either read from or written to user/hardware variable space 104), the process will proceed to update file/variable status state 506 for read/write operations.

In one embodiment, the process will proceed to update file/variable status state 506 on one of a read or a write operation, but not both. This too may be dictated by the policy of the system (i.e., what the system can support as far as overhead, for example) and implemented via main system firmware image 102.

During update file/variable status state 506, a file/variable that is used is either written to or read from user/hardware variable space 104. At this time, the date/time field information relating to the file/variable is updated to enter the last time the file/variable was accessed.

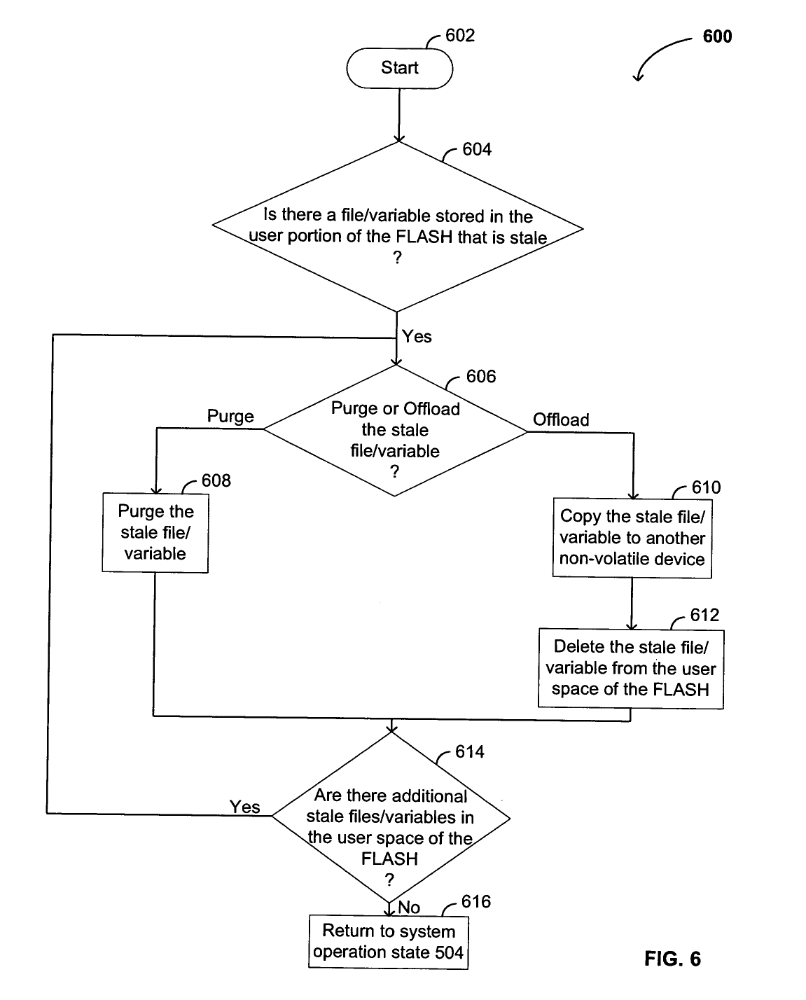

On completion of updating the file/variable date/time access field information, the process proceeds to a maintain user FLASH space state 508. In maintain user FLASH space state 508, the system will locate all “stale” files/variables in user/hardware variable space 104 and either purge or offload any “stale” files/variables to free up user space in user/hardware variable space 104 for other legitimate uses. A process describing the maintenance of user FLASH space is described below with reference to FIG. 6. On completion of maintain user FLASH space state 508, the process then returns back to perform system operation state 504 to continue system operations.

Note that when the process is at any of states 504, 506, or 508, on a system boot or system reset, the process will return to system initialization state 502.

FIG. 6 is a flow diagram illustrating an exemplary method for managing FLASH utilization as it pertains to unused or infrequently referenced FLASH data according to an embodiment of the present invention. The invention is not limited to the embodiment described herein with respect to flow diagram 600. Rather, it will be apparent to persons skilled in the relevant art(s) after reading the teachings provided herein that other functional flow diagrams are within the scope of the invention. The process begins with block 602, where the process immediately proceeds to block 604.

In decision block 604, the system determines whether a file/variable stored in user/hardware variable space 104 is “stale”. This is determined by the last accessed data/time field, (i.e., when the file/variable was last written to or read from user/hardware variable space 104). If a file/variable has been stored in user/hardware variable space 104 at least X days (or in excess of what system policy indicates is allowable) without being accessed, the file/variable is considered to be “stale”. As previously indicated, policy may be based on heuristics that are platform specific. For example, data considered to be “stale” for a server may be different for a desktop or another type of computing device. Thus, in one embodiment, X days may be 100 days. In another embodiment, X days may be 30 days. If the file/variable is determined to be “stale”, the process then proceeds to decision block 606.

In decision block 606, it is determined whether to purge the “stale” file/variable or to offload the “stale” file/variable to another non-volatile storage device. In embodiments, whether to purge or offload the “stale” file/variable may be based on policy. For example, in some platforms, policy may dictate that “stale” files/variables are not to be deleted because they may be needed at a later time. In this instance, the firmware is enabled to offload the “stale” file/variable to an alternate storage device. In one embodiment, the user may be given a choice as to which alternate storage location to offload the “stale” file/variable. In another embodiment, the selection of the alternate storage location may be policy driven. Alternatively, policy may dictate that all “stale” files/variables be purged from the system completely. If it is determined to purge the “stale” file/variable, the process proceeds to block 608.

In block 608, the “stale” file/variable is purged from the system, leaving the space in user/hardware variable space 104 available for use by other users, firmware or agents/devices. The process then proceeds to decision block 614.

Returning to decision block 606, if it is determined to offload the “stale” file/variable to another non-volatile storage device, the process proceeds to block 610.

In block 610, the “stale” file/variable is copied to an alternate storage location that is capable of storing the “stale” file/variable for an indefinite period of time. The alternate storage location may be a Host Protect Area (HPA) of a hard drive, another location on the hard drive, a tape, a writeable CD (compact disk), a floppy disk, a remote location, such as a network file share, or any other non-volatile storage means with the capability for storing such data. Later, when the offloaded “stale” file/variable is needed, the system will know to look to the alternate storage location if the file/variable is not found in user/hardware variable space 104 in FLASH 100. The process then proceeds to block 612.

In block 612, the “stale” file/variable is deleted from user/hardware variable space 104. The process then proceeds to decision block 614.

In decision block 614, it is determined whether additional “stale” files/variables are found in user/hardware variable space 104. If additional “stale” files/variables are found in user/hardware variable space 104, then the process returns to decision block 606 to determine whether to purge or offload the remaining “stale” files/variables. If additional “stale” files/variables are not found in user/hardware variable space 104, then the process proceeds back to system operation state 504 in FIG. 5 to continue system operations.

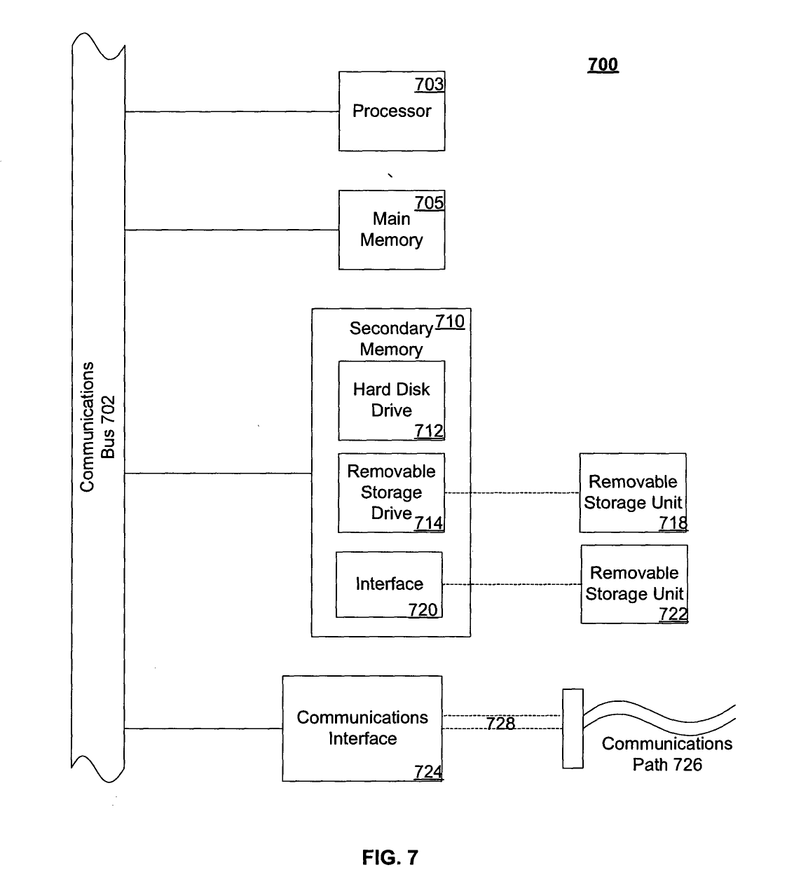

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 700 is shown in FIG. 7. Various embodiments are described in terms of this exemplary computer system 700. After reading this description, it will be apparent to a person skilled in the relevant art how to implement the invention using other computer systems and/or computer architectures.

Computer system 700 includes one or more processors, such as processor 703. Processor 703 is connected to a communication bus 702. Computer system 700 also includes a main memory 705, preferably random access memory (RAM) or a derivative thereof (such as SRAM, DRAM, etc.), and may also include a secondary memory 710. Secondary memory 710 may include, for example, a hard disk drive 712 and/or a removable storage drive 714, representing a floppy disk drive, a magnetic tape drive, an optical disk drive, etc. Removable storage drive 714 reads from and/or writes to a removable storage unit 718 in a well-known manner. Removable storage unit 718 represents a floppy disk, magnetic tape, optical disk, etc., which is read by and written to by removable storage drive 714. As will be appreciated, removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an EPROM (erasable programmable read-only memory), PROM (programmable read-only memory), or FLASH memory, such as FLASH memory device 100 ) and associated socket, and other removable storage units 722 and interfaces 720 which allow software and data to be transferred from removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a PCMCIA (personal computer memory card international association) slot and card, a wireless LAN (local area network) interface, etc. Software and data transferred via communications interface 724 are in the form of signals 728 which may be electronic, electromagnetic, optical or other signals capable of being received by communications interface 724. These signals 728 are provided to communications interface 724 via a communications path (ie., channel) 726. Channel 726 carries signals 728 and may be implemented using wire or cable, fiber optics, a phone line, a cellular phone link, a wireless link, and other communications channels.

In this document, the term “computer program product” refers to removable storage units 718, 722, and signals 728. These computer program products are means for providing software to computer system 700. Embodiments of the invention are directed to such computer program products.

Computer programs (also called computer control logic) are stored in main memory 705, and/or secondary memory 710 and/or in computer program products. Computer programs may also be received via communications interface 724. Such computer programs, when executed, enable computer system 700 to perform the features of the present invention as discussed herein. In particular, the computer programs, when executed, enable processor 703 to perform the features of embodiments of the present invention. Accordingly, such computer programs represent controllers of computer system 700.

In an embodiment where the invention is implemented using software, the software may be stored in a computer program product and loaded into computer system 700 using removable storage drive 714, hard drive 712 or communications interface 724. The control logic (software), when executed by processor 703, causes processor 703 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. A method for managing memory usage comprising:
determining whether a file stored on a user/hardware accessible portion of a non-volatile memory device in a computing system has been accessed within a pre-determined period; and
if the file has not been accessed within the pre-determined period, purging the file to enable the recovery of storage space in the user/hardware accessible portion of the non-volatile memory device being occupied by unused or infrequently accessed files.

2. The method of claim 1, wherein a file comprises a variable.

3. The method of claim 1, wherein access-aging policies based on heuristics that are platform specific to the computing system are used to determine whether a file stored on the user/hardware accessible portion of the non-volatile memory device has been accessed within a pre-determined period.

4. The method of claim 1, wherein purging the file comprises deleting the file from the user/hardware accessible portion of the non-volatile memory device.

5. The method of claim 1, wherein purging the file comprises deleting the file from the computing system.

6. The method of claim 1, wherein purging the file comprises offloading the file to an alternative non-volatile memory device capable of storing the file indefinitely.

7. The method of claim 6, wherein the non-volatile memory device comprises a FLASH memory device and wherein offloading the file to an alternative non-volatile memory device comprises:
copying the file to the alternative non-volatile memory device; and
deleting the file from the FLASH memory device.

8. The method of claim 1, wherein the non-volatile memory device comprises a first non-volatile memory device and wherein purging the file comprises:
copying the file to a second non-volatile memory device capable of storing the file for an indefinite period of time; and
deleting the file from the first non-volatile memory device.

9. The method of claim 8, wherein the first non-volatile memory device comprises a non-volatile random access memory device and the second non-volatile memory device comprises at least one of a hard drive, a tape drive, a writeable compact disk (CD) drive, a floppy disk drive, and a remote location on a network.

10. The method of claim 1, wherein the non-volatile memory device comprises a non-volatile random access memory (NVRAM) device.

11. The method of claim 10, wherein the NVRAM device comprises a FLASH memory device.

12. The method of claim 11, wherein the FLASH memory device comprises a main system firmware portion and the user/hardware accessible portion, wherein the memory capacity of the main system firmware portion is larger than the memory capacity of the user/hardware accessible portion.

13. The method of claim 12, wherein the main system firmware portion comprises computer program code to maintain the user/hardware accessible portion of the non-volatile memory device.

14. The method of claim 1, wherein determining whether a file stored on a user/hardware accessible portion of a non-volatile memory device in a computing system has been accessed within a pre-determined period further comprises determining whether the file is stale.

15. The method of claim 14, wherein a user interacts with the computing system to determine which stale files in a list of files indicated as being stored on the user/hardware accessible portion of the non-volatile memory device are selected to be purged.

16. The method of claim 1, further comprising monitoring the user/hardware accessible portion of the non-volatile memory device to prevent depletion of available user/hardware accessible space.

17. The method of claim 16, wherein monitoring the user/hardware accessible portion of the non-volatile memory device comprises altering access-aging policies to accelerate the purging of files from the user/hardware accessible portion to prevent depletion of the any remaining user/hardware accessible space.

18. The method of claim 1, further comprising monitoring available user/hardware accessible space to prevent storage of files comprising storage allotments that exceed or limit the amount of the available user/hardware accessible space.

19. The method of claim 1, wherein purging the file comprises offloading the file to an alternative non-volatile memory device capable of storing the file indefinitely, wherein if the file is needed, the computing system will retrieve the file from the alternative non-volatile memory device when the file is not found in the user/hardware accessible portion of the non-volatile memory device.

20. An article comprising: a storage medium having a plurality of machine accessible instructions, wherein when the instructions are executed by a processor, the instructions provide for determining whether a file stored on a user/hardware accessible portion of a non-volatile memory device in a computing system has been accessed within a pre-determined period; and
if the file has not been accessed within the pre-determined period, purging the file to enable the recovery of storage space in the user/hardware accessible portion of the non-volatile memory device being occupied by unused or infrequently accessed files.

21. The article of claim 20, wherein a file comprises a variable.

22. The article of claim 20, wherein access-aging policies based on heuristics that are platform specific to the computing system are used to determine whether a file stored on the user/hardware accessible portion of the non-volatile memory device has been accessed within a pre-determined period.

23. The article of claim 20, wherein instructions for purging the file comprises instructions for deleting the file from the user/hardware accessible portion of the non-volatile memory device.

24. The article of claim 20, wherein instructions for purging the file comprises instructions for deleting the file from the computing system.

25. The article of claim 20, wherein instructions for purging the file comprises instructions for offloading the file to an alternative non-volatile memory device capable of storing the file indefinitely.

26. The article of claim 25, wherein the non-volatile memory device comprises a FLASH memory device and wherein instructions for offloading the file to an alternative non-volatile memory device comprises instructions for:
copying the file to the alternative non-volatile memory device; and
deleting the file from the FLASH memory device.

27. The article of claim 20, wherein the non-volatile memory device comprises a first non-volatile memory device and wherein instructions for purging the file comprises instructions for:
copying the file to a second non-volatile memory device capable of storing the file for an indefinite period of time; and
deleting the file from the first non-volatile memory device.

28. The article of claim 27, wherein the first non-volatile memory device comprises a non-volatile random access memory device and the second non-volatile memory device comprises at least one of a hard drive, a tape drive, a writeable compact disk (CD) drive, a floppy disk drive, and a remote location on a network.

29. The article of claim 20, wherein the non-volatile memory device comprises a non-volatile random access memory (NVRAM) device.

30. The article of claim 29, wherein the NVRAM device comprises a FLASH memory device.

31. The article of claim 30, wherein the FLASH memory device comprises a main system firmware portion and the user/hardware accessible portion, wherein the memory capacity of the main system firmware portion is larger than the memory capacity of the user/hardware accessible portion.

32. The article of claim 31, wherein the main system firmware portion comprises computer program code to maintain the user/hardware accessible portion of the non-volatile memory device.

33. The article of claim 20, wherein instructions for determining whether a file stored on a user/hardware accessible portion of a non-volatile memory device in a computing system has been accessed within a pre-determined period further comprises instructions for determining whether the file is stale.

34. The article of claim 33, wherein a user interacts with the computing system to determine which stale files in a list of files indicated as being stored on the user/hardware accessible portion of the non-volatile memory device are selected to be purged.

35. The article of claim 20, further comprising instructions for monitoring the user/hardware accessible portion of the non-volatile memory device to prevent depletion of available user/hardware accessible space.

36. The article of claim 35, wherein instructions for monitoring the user/hardware accessible portion of the non-volatile memory device comprises instructions for altering access-aging policies to accelerate the purging of files from the user/hardware accessible portion to prevent depletion of the any remaining user/hardware accessible space.

37. The article of claim 20, further comprising instructions for monitoring available user/hardware accessible space to prevent storage of files comprising storage allotments that exceed or limit the amount of the available user/hardware accessible space.

38. The article of claim 20, wherein instructions for purging the file comprises instructions for offloading the file to an alternative non-volatile memory device capable of storing the file indefinitely, wherein if the file is needed, the computing system will retrieve the file from the alternative non-volatile memory device when the file is not found in the user/hardware accessible portion of the non-volatile memory device.

39. A computing system comprising
a processor; and
a non-volatile memory device coupled to the processor, the non-volatile memory device comprising a main system firmware portion and a user/hardware accessible portion, the main system firmware portion comprising computer program code for enabling the process to manage memory usage of the user/hardware accessible portion.

40. The computing system of claim 39, wherein the non-volatile memory device comprises at least one non-volatile random access memory (NVRAM) device.

41. The computing system of claim 39, wherein the computer program code of the main system firmware portion includes access-aging policies based on heuristics that are platform specific to enable management of the memory usage of the user/hardware accessible portion, wherein files stored within the user/hardware accessible portion are purged when the files have not been accessed within a pre-determined period of time.

42. The computing system of claim 39, wherein the memory capacity of the user/hardware accessible portion is less than the memory capacity of the main system firmware portion of the non-volatile memory.

43. The computing system of claim 39, further comprising an alternate non-volatile storage device, wherein files stored within the user/hardware accessible portion that have not been accessed within a pre-determined period of time are offloaded to the alternate non-volatile storage device, wherein the alternate non-volatile storage device is capable of storing the files indefinitely.
